(19) United States
(12) Patent Application Publication
(10) Pub. No.: US 2010/0001664 A1
(43) Pub. Date: Jan. 7, 2010

(54) Illuminating fabric product

(76) Inventor: Shu-Chuan Shih, Chino Hills, CA (US)

Correspondence Address: DAVID AND RAYMOND PATENT FIRM, 108 N. YNEZ AVE., SUITE 128, MONTEREY PARK, CA, 91754, US

(21) Appl. No.: 12/380,390

(22) Filed: Feb. 25, 2009

Related U.S. Application Data
(60) Provisional application No. 61/067,301, filed on Feb. 26, 2008.

(51) Int. Cl. H05B 39/00; F21S 4/00; F21L 4/02

(52) U.S. Cl. 315/313; 362/249.16; 362/184

(57) ABSTRACT

An illuminating fabric product includes an elongated fabric ribbon adapted to be selectively folded to form a decorative fabric product, and a light string longitudinally extended along the fabric ribbon, wherein the light string includes a power supply, a plurality of spacedly apart illuminators provided at the fabric ribbon, and an electric wire electrically linked the illuminators with the power supply. When the light string is folded within the fabric ribbon to form the decorative fabric product, the illuminators are adapted for generating a light effect to produce an illuminating effect for the decorative fabric product.

### CROSS REFERENCE OF RELATED APPLICATION

This is a non-provisional application of a provisional application having an application No. 61/067,301 and a filing date of Feb. 26, 2008.

### BACKGROUND OF THE PRESENT INVENTION

1. Field of Invention

The present invention relates to a fabric product, and more particularly to an illuminating fabric product, which is capable of producing an illuminating effect on an ordinary fabric product, so as to enhance a decoration effect.

2. Description of Related Arts

Mostly at night, lamp strips are always used for decorating tress, architectures, houses, or indoors decoration to bring a festival atmosphere in the festivals, such as Christmas or New Year's Eve. The lamp strip is a plurality of lamps connected in series or parallel by wires, forming a strip of lamps. The lamps can be always shining or set to glitter. However, such a lamp is usually big in size, so that it is only suitable for decorating a large area.

LEDs as an illuminating light have been widely used in decoration area indoors or outdoors. Due to its small size and long life span, the LED becomes more and more popular. The LED strips are usually hung around the Christmas trees, so as to producing an illuminating effect. Especially in a dark place or at night, the Christmas tree becomes shining and more beautiful, bring people happy environment and good mood. Also the LED strip can be used in the similar circumstance. However, the LED strip can only shine or glitter and with no further enhanced effect.

Ribbon is also a popular decoration material, which is always used at edges of clothes, hat and many others. Many types of ribbon have been developed to meet the trend and to make life more colorful. However, only patterns and colors have been changed during the past days, which is obviously cannot keep up the fast changing fashion. Therefore, a breakthrough and innovation are needed for these traditional decoration materials.

The ribbon can be used to make bowties for decoration too. Likewise, these bowties are old and lack fresh design. Therefore, it would be an advancement in the art to develop a product that can solve all the above problems.

### SUMMARY OF THE PRESENT INVENTION

A main object of the present invention is to provide an illuminating fabric product, which is capable of producing an illuminating effect on an ordinary fabric product, so as to enhance a decoration effect.

Another object of the present invention is to provide an illuminating fabric product, which comprises a light string extending along the elongated fabric, so as to produce an illuminating effect on the fabric.

Another object of the present invention is to provide an illuminating fabric product, which comprises an elongated fabric ribbon that has a hollow core for allowing the light string longitudinally extending therewithin along the elongated fabric ribbon, so as to provide an illuminating effect on the fabric.

Another object of the present invention is to provide an illuminating fabric product, wherein the light string is attached onto the fabric for securely extending along the elongated fabric, so as to produce an illuminating effect on the fabric.

Another object of the present invention is to provide an illuminating fabric product, wherein the elongated fabric is transparent or translucent for the light penetrating therethrough, and for producing a decoration effect to the light string.

Another object of the present invention is to provide an illuminating fabric product that can make illuminating bowtie of any pattern or other decoration for decoration purpose.

Another object of the present invention is to provide an illuminating fabric product, wherein the light string is extended along the elongated fabric ribbon that the illuminating fabric product can be cut and reconnected, so that the length of the illuminating fabric product is arbitrary.

Accordingly, in order to accomplish the above objects, the present invention provides an illuminating fabric product, which comprises an elongated fabric ribbon, and a light string extending along the elongated fabric ribbon, wherein the light string comprises a plurality of spaced apart illuminators provided on the light string, and electric wire electrically connecting with the illuminators, a power supply electrically connected with the electric wire for supplying power to the illuminators, so as to produce an illuminating effect on the fabric ribbon.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of an illuminating fabric product according to a preferred embodiment of the present invention.

FIG. 2 is an exploded perspective view of the illuminating fabric product according to the above preferred embodiment of the present invention.

FIG. 3 is a sectional view of the illuminating fabric product according to the above preferred embodiment of the present invention.

FIG. 4 is an alternative mode of the illuminating fabric product according to the above preferred embodiment of the present invention.

FIG. 5 is an exploded perspective view of the alternative mode of the illuminating fabric product according to the above preferred embodiment of the present invention.

FIG. 6 is sectional view of the alternative mode of the illuminating fabric product according to the above preferred embodiment of the present invention.

FIG. 7 is a perspective view of the illuminating fabric product comprising a button battery as a power supply according to the above preferred embodiment of the present invention.

FIG. 8 is a perspective view of the illuminating fabric product according to the above preferred embodiment of the present invention, illustrating how to cut and reconnect the illuminating fabric product.

FIG. 9 illustrates the LED serial connectivity of the illuminators according to the above preferred embodiment of the present invention.

FIG. 10 is a perspective view of the illuminating fabric product with the DC power supply of the illuminating fabric product according to the above preferred embodiment of the present invention.

FIG. 11 is a perspective view of the DC power supply of the illuminating fabric product according to the above preferred embodiment of the present invention.

FIG. 12 is an exploded perspective view of the DC power supply of the illuminating fabric product according to the above preferred embodiment of the present invention.

### DETAILED DESCRIPTION OF THE PREFERRED EMBODIMENT

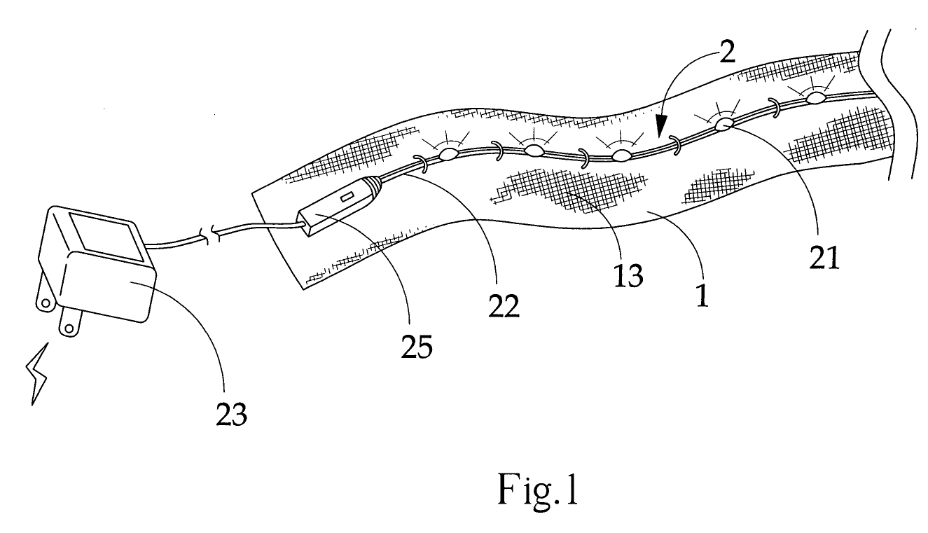

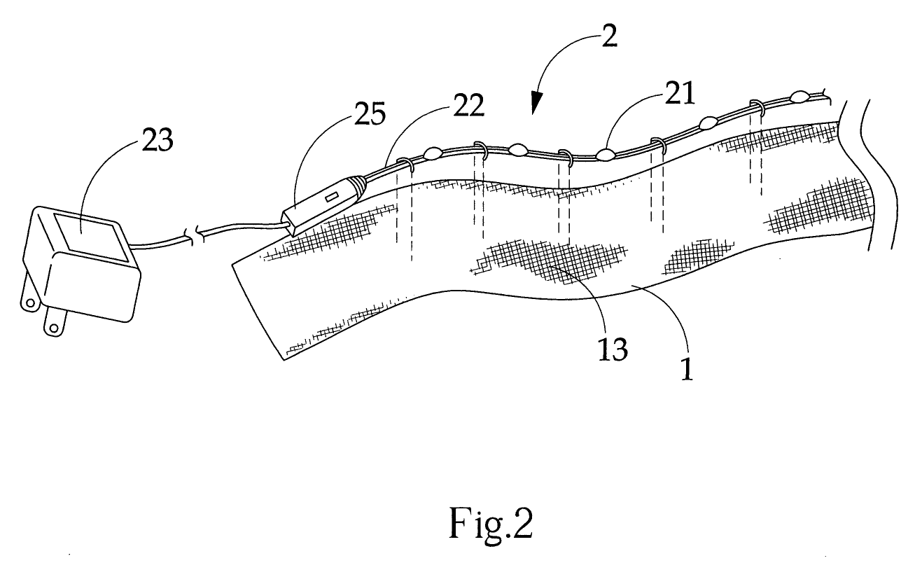

Referring to FIG. 1 and FIG. 2 of the drawings, an illuminating fabric product according to a preferred embodiment of the present invention is illustrated, in which the illuminating fabric product comprises an elongated fabric ribbon 1, and a light string 2 extending along the elongated fabric ribbon 1, wherein the light string 2 comprises a plurality of spaced apart illuminators 21 provided on the light string 2, and electric wire 22 electrically connecting with the illuminators 21, a power supply 23 electrically connected with the electric wire 22 for supplying power to the illuminators 21, so as to produce an illuminating effect on the fabric ribbon 1.

The elongated fabric ribbon 1 is ordinary decorative ribbon, which is flat and wide. The fabric ribbon 1 is adapted to be selectively folded to form a decorative fabric product. The light string 2 extends along the elongated fabric ribbon 1, and fastened to the elongated fabric ribbon 1 at regular intervals. The light string 2 is fastened to the elongated fabric ribbon 1 by sewing or tying. Alternatively, each illuminator 21 is attached to the elongated fabric ribbon 1, for example by an adhesive agent, to ensure the light string 2 is fastened on the elongated fabric ribbon 1. When the power supply 23 is switched on, the illuminators 21 radiate light through fabric ribbon 1 to produce an illuminating effect thereon. In other words, when the light string 2 is folded within the fabric ribbon 1 to form the decorative fabric product, the illuminators 21 are adapted for generating a light effect to produce the illuminating effect for the decorative fabric product.

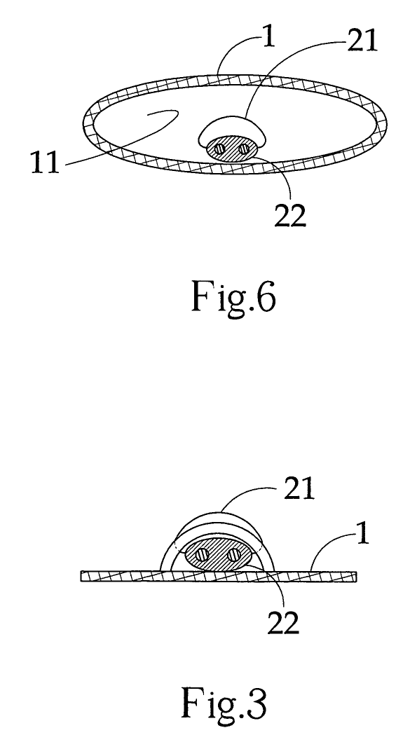

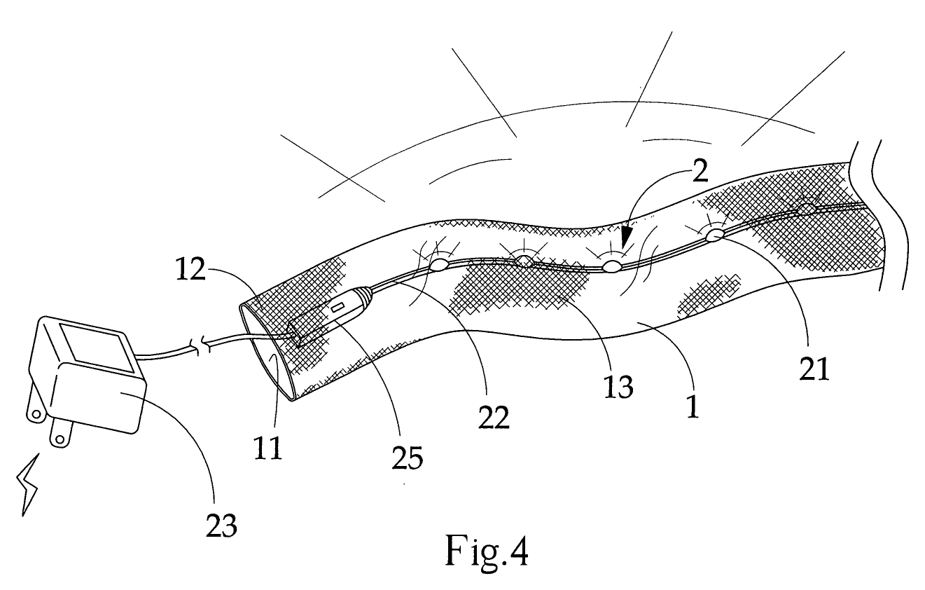

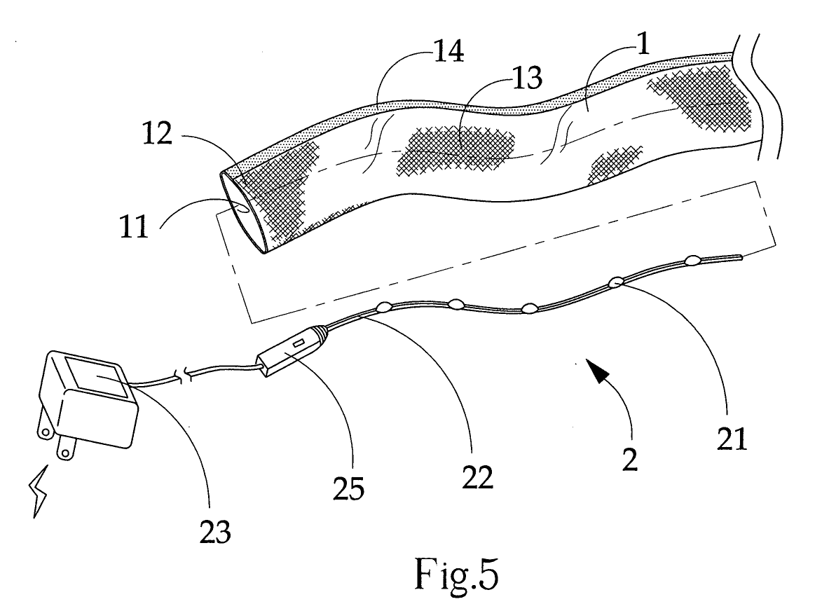

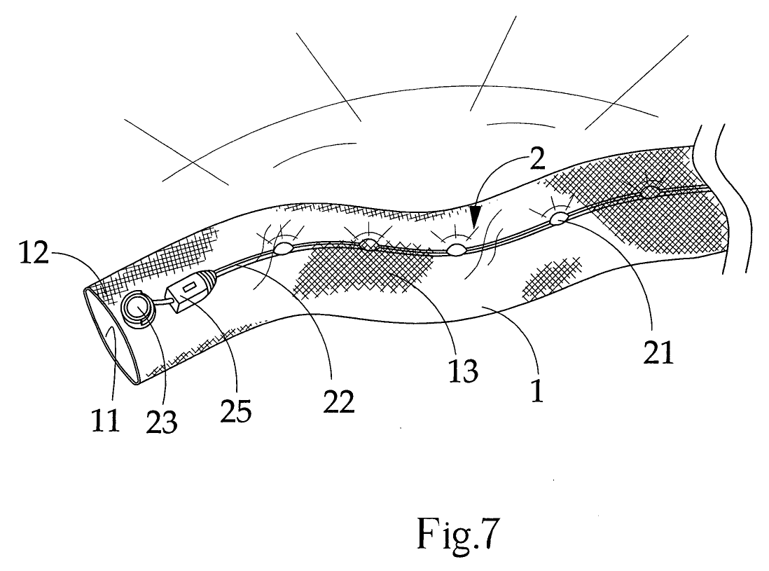

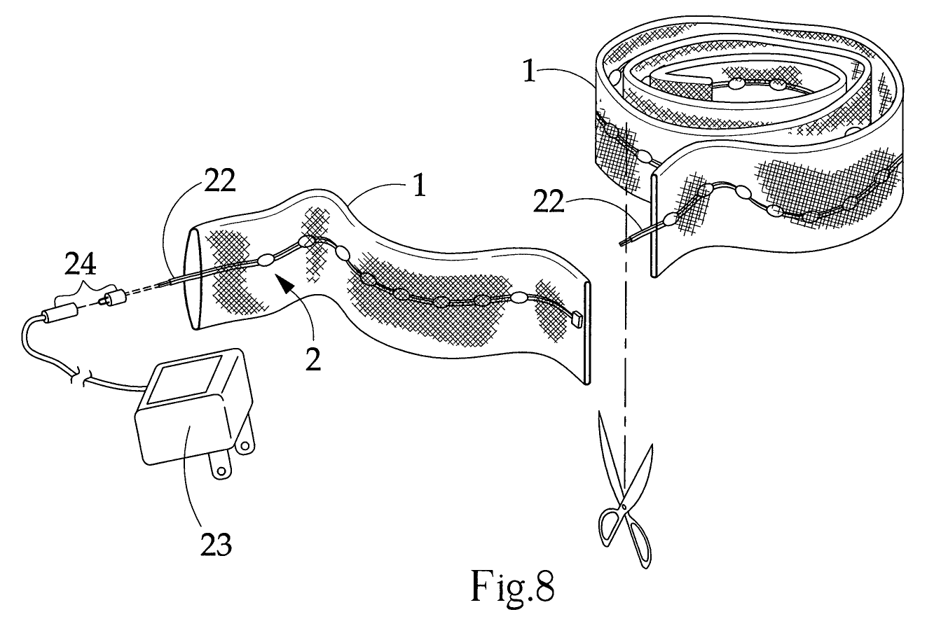

As shown in FIG. 3 of the drawings, the elongated fabric ribbon 1 has an elongated hollow core 11, so that the light string 2 is inserted into the fabric ribbon 1 for longitudinally extending within the elongated fabric. The elongated fabric ribbon 1 comprises two pieces of elongated fabric ribbon, two longitudinal side edges of which are sewed together forming the hollow core 11. Alternatively, the elongated fabric ribbon 1 is annular fabric ribbon, so that the light string 2 is slidably inserted into the annular fabric ribbon for longitudinally extending within the elongated fabric. Two end portions 12 of the elongated fabric ribbon 1 are fastened with two end portions of the electric wire of the light string 2 respectively, so as to securely receive the light string 2 inside the elongated fabric ribbon 1.

The elongated fabric ribbon 1 is made of transparent or translucent material, so that the light string 2 inside penetrates light through the elongated fabric ribbon 1. Alternatively, the elongated fabric ribbon 1 is loosely interwoven forming apertures 13 distributed along the elongated fabric ribbon 1, so that the light string 2 inside emits light through the apertures of the elongated fabric ribbon 1.

Moreover, the elongated fabric ribbon 1 further comprises at least a reflective wire 14 thereon, such as thin metal wire, golden wire, and silver wire. The reflective wire 14 is longitudinally interwoven into the elongated fabric ribbon 1. When the illuminators 21 emit lights, these reflective wires 14 reflect the lights so as to enhance the illuminating effect on the elongated fabric ribbon 1.

The illuminator 21 of the light string 2 is LED, which is popular in decoration area due to its small size and long life span. The illuminator 21 can be embodied as different colors to match the color of the elongated fabric ribbon 1, so as to produce a better illuminating effect on the elongated fabric ribbon 1.

It is worth mentioning that each LED is sealedly covered by resin so as to be waterproof. The connection of the LED and the wire is also sealedly covered by resin with LED. Therefore, the illuminating fabric product can be used outdoors, and the LEDs will not turn off accidentally. The light string 2 can be embodied as a light rope, wherein the illuminators 21 of the light string 2 emit light as rope light source, and not a plurality of discrete point source, which can produce a different type of illuminating effect on the elongated fabric ribbon 1.

The light string 2 comprises at least one electric wire 22 to electrically connect the illuminators 21. The light string 2 further comprises one or more electric wires 22 to electrically connect the illuminators 21 respectively. The light string 2 further comprises a switch 25 provided between the electric wire 22 and the power supply 23 for controlling the electrical connection of the light string 2.

When the elongated fabric ribbon 1 is too long to be used, the elongated fabric ribbon 1 can be cut at any place. The electric wire 22 along the elongated fabric ribbon 1 is cut off, and reconnected to the power supply 23 directly such that the power supply 23 is detachably connected with the electric wire 22 to electrically link with the illuminators 21. The light string 2 of the illuminating fabric product further comprises a connector 24 for reconnecting the cut electric wire 22 to the power supply 23. Likewise, when the elongated fabric ribbon 1 is too short to be used, cut off the original connection between the electric wire 22 and the power supply 23, and connect the cut electric wire 22 with another cut electric wire 22 together, so as to connect two illuminating fabric products together.

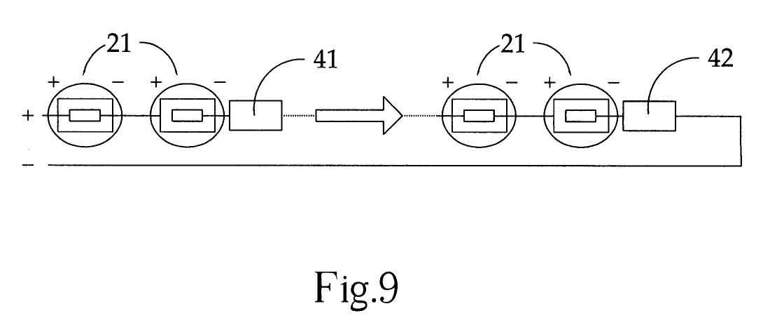

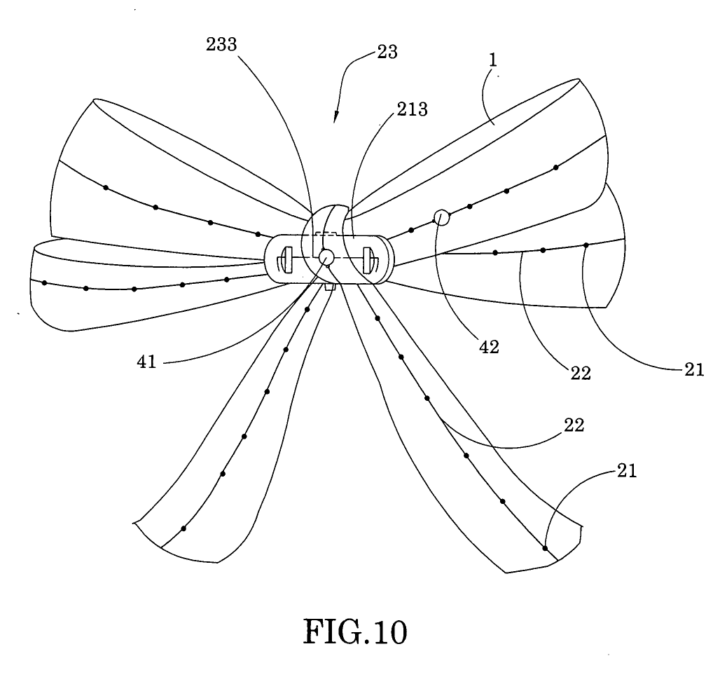

The power supply 23 can be a plug to plug with an ordinary A/C electrical socket for electrically connecting the electric wire 22 of the light string 2 to provide power to the illuminators 21 of the light string 2. The electric wire 22 comprises a connecter for connecting the electric wire 22 to the A/C power supply. The power supply 23 is also embodied as a battery which is ordinary AA battery, Li battery, or small button battery. The Li button battery is small in size, which can be portably used. In other words, the power supply 23 is a DC power supply 23 to electrically link with the illuminators 21. FIG. 9 shows the LED serial connectivity of the illuminators 21.

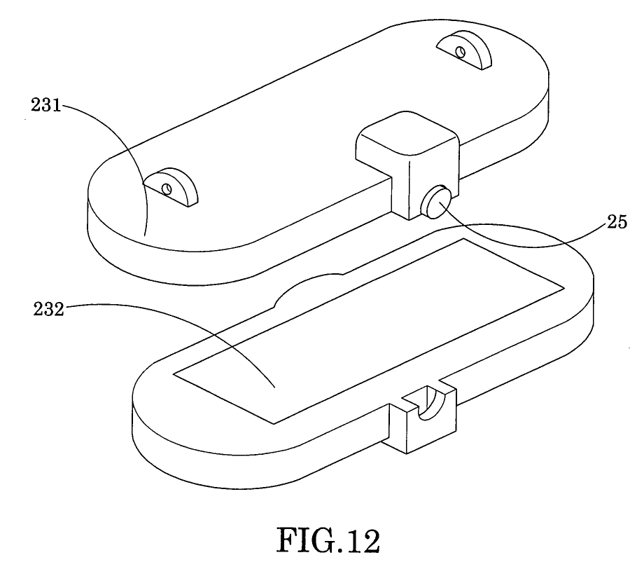

As shown in FIGS. 10 to 12, the power supply 23 comprises a battery casing 231 receiving a battery 232 therein to electrically couple with the electric wire 22 and a fixation element 233 provided at a rear wall of the battery casing 231 to detachably affix to the fabric ribbon 1 so as to retain the power supply 23 in position. Accordingly, the fixation element 233 is a fixation pin longitudinally provided at the rear wall of the battery casing 231 for detachably affixing to the fabric ribbon 1. As shown in FIG. 10, the fabric ribbon 1 is folded into a bow that the fixation element 233 is affixed to the tying portion of the bow.

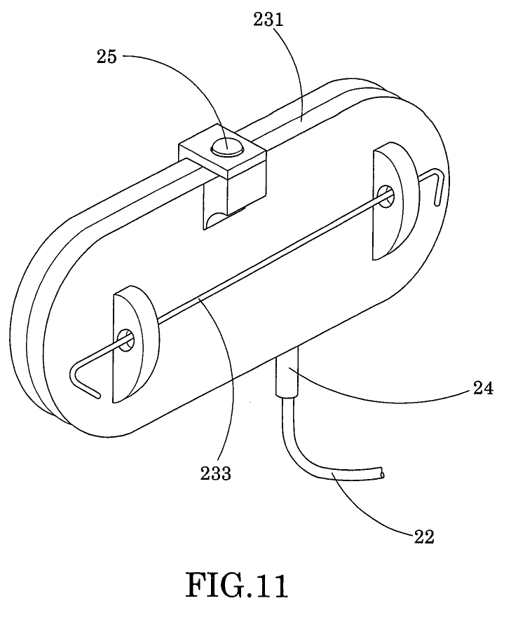

As shown in FIG. 11, the electric wire 22 is detachably connected to the battery 232 at the battery casing 231 via the connector 24. In addition, the battery 232 can be a replaceable battery or a rechargeable battery (Li battery) received in the battery casing 231. The switch 25 is provided at the battery casing 231 to electrically connect with the electric wire 22 for operatively controlling the illuminators 21 in an on-and-off manner.

In addition, the illuminating fabric product further comprises a sensor 41 and a speaker 42 electrically coupling with the electric wire 22, preferably by the connectors 24, to electrically link with the illuminators 21 of the light string 2 such that when the sensor 41 is activated, the illuminators 21 will generate light effect while the speaker 42 will generate sound effect as well. Preferably, the sensor 41 is a motion sensor to detect the motion of the illuminating fabric product, especially when the user holds the illuminating fabric product. The speaker 42 has a built-in music program to generate the sound effect. It is worth to mention that the sensor 41 and the speaker 42 can be electrically connected to the illuminators 21 in serial connection via the DC power supply 23.

The illuminating fabric product can be used to make bowtie, or other decoration, which can be mounted on the wall or other place for decoration purpose. Therefore, such decoration can illuminate at dark place or at night to make the bowtie or other decoration more shining and beautiful.

The illuminating fabric product also can be sewed at edges of clothes, hat or many others to produce an illuminating effect on clothes. User can wear these clothes or hat in club, at party, or even on stage. Definitely, the user wearing such clothes or hat is more shining and attractive among the people. In addition, the fabric ribbon 1 can be made of PVC material to product tree skirt, stocking, hat, clothing, carpet, table cover and runner, chair cover and sashes, window curtains and drape, etc. . . . , for producing the illuminating effect on the fabric so as to enhance the aesthetic appearance of the product.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An illuminating fabric product, comprising:
an elongated fabric ribbon adapted to be selectively folded to form a decorative fabric product; and
a light string, which is longitudinally extended along said fabric ribbon, comprising a power supply, a plurality of spacedly apart illuminators provided at said fabric ribbon, and an electric wire electrically linked said illuminators with said power supply, wherein said light string is folded within said fabric ribbon to form said decorative fabric product in such a manner that said illuminators are adapted for generating a light effect to produce an illuminating effect for said decorative fabric product.

2. The illuminating fabric product, as recited in claim 1, wherein said fabric ribbon has an elongated hollow core that said light string is slidably disposed within said hollow core of said fabric ribbon, wherein two end portions of said light string are fastened with two end portions of said fabric ribbon respectively to securely retain said light string within said fabric ribbon.

3. The illuminating fabric product, as recited in claim 1, further comprising at least a connector electrically connecting said electric wire of said light string with said electric wire of another said light string to selectively prolong a length of said light string.

4. The illuminating fabric product, as recited in claim 2, further comprising at least a connector electrically connecting said electric wire of said light string with said electric wire of another said light string to selectively prolong a length of said light string.

5. The illuminating fabric product, as recited in claim 1, wherein said fabric ribbon is made of light transmissible material that said illuminators generate said light effect adapted for penetrating through said fabric ribbon.

6. The illuminating fabric product, as recited in claim 2, wherein said fabric ribbon is made of light transmissible material that said illuminators generate said light effect adapted for penetrating through said fabric ribbon.

7. The illuminating fabric product, as recited in claim 4, wherein said fabric ribbon is made of light transmissible material that said illuminators generate said light effect adapted for penetrating through said fabric ribbon.

8. The illuminating fabric product, as recited in claim 1, wherein said light string is interwoven with said fabric ribbon.

9. The illuminating fabric product, as recited in claim 4, wherein said light string is interwoven with said fabric ribbon.

10. The illuminating fabric product, as recited in claim 7, wherein said light string is interwoven with said fabric ribbon.

11. The illuminating fabric product, as recited in claim 1, wherein said fabric ribbon comprises at least a reflective wire interweaving longitudinally such that when said light effect is generated by said illuminators, said reflective wire reflects said light effect for enhancing said illuminating effect along said fabric ribbon.

12. The illuminating fabric product, as recited in claim 7, wherein said fabric ribbon comprises at least a reflective wire interweaving longitudinally such that when said light effect is generated by said illuminators, said reflective wire reflects said light effect for enhancing said illuminating effect along said fabric ribbon.

13. The illuminating fabric product, as recited in claim 10, wherein said fabric ribbon comprises at least a reflective wire interweaving longitudinally such that when said light effect is generated by said illuminators, said reflective wire reflects said light effect for enhancing said illuminating effect along said fabric ribbon.

14. The illuminating fabric product, as recited in claim 1, wherein said power supply is detachably coupling with said electric wire to electrically link with said illuminators.

15. The illuminating fabric product, as recited in claim 13, wherein said power supply is detachably coupling with said electric wire to electrically link with said illuminators.

16. The illuminating fabric product, as recited in claim 14, wherein said power supply is a DC power supply.

17. The illuminating fabric product, as recited in claim 15, wherein said power supply is a DC power supply.

18. The illuminating fabric product, as recited in claim 1, wherein said light string further comprises a switch provided between said electric wire and said power supply for controlling an electrical connection of said light string.

19. The illuminating fabric product, as recited in claim 7, wherein said light string further comprises a switch provided between said electric wire and said power supply for controlling an electrical connection of said light string.

20. The illuminating fabric product, as recited in claim 17, wherein said light string further comprises a switch provided between said electric wire and said power supply for controlling an electrical connection of said light string.
